(19) United States
(12) Patent Application Publication
(10) Pub. No.: US 2008/0075308 A1
(43) Pub. Date: Mar. 27, 2008

(54) SILICON CONDENSER MICROPHONE

(76) Inventors: Wen-Chieh Wei, Taichung (TW); Hong-Ching Her, Taichung (TW); Shih-Chin Gong, Taipei (TW); Cyuan-Sian Jeng, Yuan Li Town (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/468,658

(22) Filed: Aug. 30, 2006

(51) Int. Cl. H04R 25/00; H04R 17/02; H04R 19/04

(52) U.S. Cl. 381/175; 381/369

(57) ABSTRACT

A silicon condenser microphone includes a silicon substrate defining an air chamber, a back plate mounted on the silicon substrate, a diaphragm arranged between the silicon substrate and the back plate and a suspension device arranged between the diaphragm and the silicon substrate. The back plate includes at least one acoustic aperture defined therein and a support device formed thereon. The diaphragm is arranged between the silicon substrate and the back plate so that an effective area thereof is determined by the support device. The suspension device is arranged between the diaphragm and the silicon substrate so that lateral movement of the diaphragm is prevented while vertical movement of the diaphragm is allowed. An edge of the diaphragm is abutted against the support device when the diaphragm is moved towards the back plate.

### BACKGROUND OF INVENTION

1. Field of Invention

The present invention relates to a silicon condenser microphone.

2. Related Prior Art

As electronic products are getting smaller and lighter, it is becoming more critical to reduce the sizes of microphones. Diaphragms for use in microphones were made of mylar in early days. However, intrinsic stress in the material is too high so that sound sensitivity is too low.

To increase the sound sensitivity, semiconductor-manufacturing processes and silicon micromachining are used to make silicon condenser microphones. In the silicon condenser microphones, which are made by the semiconductor-manufacturing processes and the silicon micromachining, diaphragms are made of silicon or silicon compounds because the intrinsic stress is low so that the sound sensitivity is high.

In U.S. Pat. No. 5,888,845, there is disclosed a silicon condenser microphone including a flat diaphragm 100 and a back plate 110. The flat diaphragm 100 is made of single-crystal silicon. The flat diaphragm 100 is secured along four edges. However, the sensitivity of the silicon condenser microphone is much affected by the manufacturing process because there is large intrinsic stress.

In U.S. Pat. No. 5,870,482, there is disclosed a single-chip silicon condenser microphone including a diaphragm 100a, a corrugated structure 102, an end 103 of fixed boundary conditions and an end 103a of free boundary conditions. This single-chip silicon condenser microphone is made by a semiconductor-manufacturing process and a silicon micromachining. The diaphragm 100a is a corrugated structure. By changing the boundary conditions of the diaphragm 100a, the intrinsic stress in the diaphragm 100a is reduced so that the sensitivity is increased. However, because of this cantilever design, the effective area of a variable condenser 60 is small so that signals generated by the variable condenser 60 are weak. Moreover, the natural resonance of the diaphragm 100a is low; however, it should be outside the telephony band. Therefore, it is difficult to design the single-chip silicon microphone.

In U.S. Pat. No. 6,535,460, there is disclosed a single-chip silicon condenser microphone including a diaphragm 112, a back plate 140 with apertures defined therein and a silicon substrate 1 30. There is an air gap 120 between the diaphragm 112 and the back plate 140. This single-chip silicon condenser uses a planar curved shape to achieve a high-compliance spring so that the diaphragm 112 is freely movable laterally. However, this planar spring needs a large area to achieve a large area of the single-chip silicon microphone.

As W. J. Wang, R. M. Lin, Q. B. Zou and X. X. Li have disclosed in “Modeling and Characterization of a Silicon Condenser Microphone,” J. Micromech. Microeng., volume 14, pp. 403-409, 2004, a poly-crystalline silicon condenser microphone including a single deeply corrugated diaphragm 100b made of poly-crystalline silicon, a corrugated structure 102a, a back plate 110a and a plurality of bonding pads 111. It is mentioned that the sensitivity gets higher and the corrugation gets deeper; however, the manufacturing gets more difficult.

The present invention is therefore intended to obviate or at least alleviate the problems encountered in prior art.

### SUMMARY OF INVENTION

According to the present invention, a silicon condenser microphone includes a silicon substrate defining an air chamber, a back plate mounted on the silicon substrate, a diaphragm arranged between the silicon substrate and the back plate and a suspension device arranged between the diaphragm and the silicon substrate. The back plate includes at least one acoustic aperture defined therein and a support device formed thereon. The diaphragm is arranged between the silicon substrate and the back plate so that an effective area thereof is determined by the support device. The suspension device is arranged between the diaphragm and the silicon substrate so that lateral movement of the diaphragm is prevented while vertical movement of the diaphragm is allowed. An edge of the diaphragm is abutted against the support device when the diaphragm is moved towards the back plate.

The primary advantage of the silicon condenser microphone according to the present invention is high sensitivity due to small stress in the diaphragm.

Other advantages and features of the present invention will become apparent from the following description referring to the drawings.

### BRIEF DESCRIPTION OF DRAWINGS

The present invention will be described through detailed illustration of three embodiments referring to the drawings.

FIG. 1 is a cross-sectional view of a silicon condenser microphone according to the first embodiment of the present invention.

FIG. 2 is a top view of the silicon condenser microphone of FIG. 1.

FIG. 3 is a top view of a silicon condenser microphone according to the second embodiment of the present invention.

FIG. 4 is a cross-sectional view of the silicon condenser according to the third embodiment of the present invention.

### DETAILED DESCRIPTION OF EMBODIMENTS

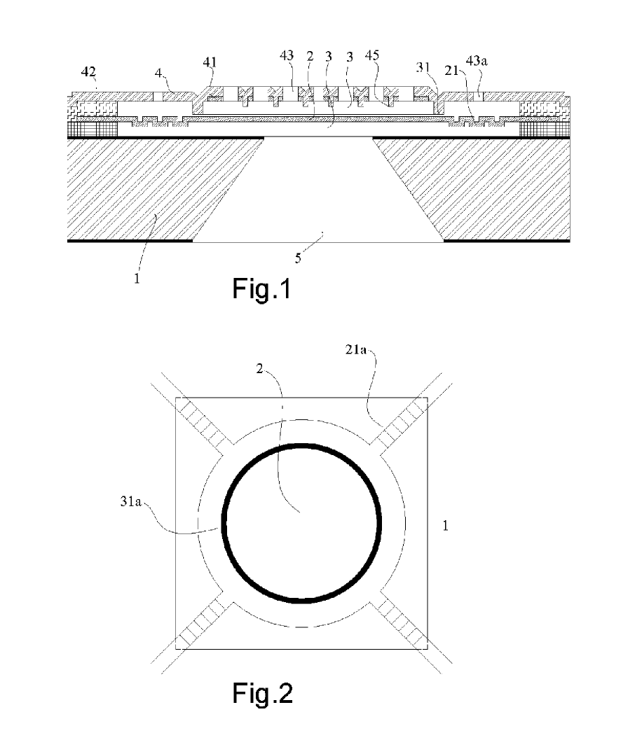

Referring to FIGS. 1 and 2, there is a silicon condenser microphone according to a first embodiment of the present invention. The silicon condenser microphone includes a silicon substrate 1, a diaphragm 2, a back plate 4 and an upper electrode 41.

The silicon substrate 1 includes an air chamber 5 defined therein.

The diaphragm 2 is mounted on the silicon substrate 1 so that the diaphragm 2 is aligned with the air chamber 5. The diaphragm 2 is suspended on the silicon substrate 1 by a suspension device 21. The suspension device 21 includes a plurality of corrugated cantilevers 21 a each including an end extended from the diaphragm 2 and an opposite end connected to the silicon substrate 1. Because of the suspension device 21, lateral movement of the diaphragm 2 is prevented while vertical movement of the diaphragm 2 is allowed. Hence, the stress in the diaphragm 2 is reduced while the sensitivity of the silicon condenser microphone is increased.

The back plate 4 is mounted on the silicon substrate 1 so that the diaphragm 2 is positioned between the silicon substrate 1 and the back plate 4. The back plate 4 includes a plurality of acoustic apertures 43 defined therein, a plurality of etching apertures 43a defined therein, an anti-sticking device 45 formed on a first side, a support device 31 formed on the first surface around the acoustic apertures 43 and a protective layer 42 formed on a second surface opposite to the first surface.

The acoustic apertures 43 are located within a region corresponding to the diaphragm 2. Sound can reach the diaphragm 2 through the acoustic apertures 43. The etching apertures 43a are used for the wet etching of internal layers.

The support device 31 is used to define an effective area of the diaphragm 2 that is vulnerable to variation in sound pressure. The support device 31 is made of a dielectric material. In the first embodiment, the support device 31 includes an annular ridge 31a.

The anti-sticking device 45 includes a plurality of bosses. The bosses of the anti-sticking device 45 may be made of a dielectric material to avoid the sticking of the diaphragm 2 to the back plate 4 during the manufacturing of the silicon condenser microphone.

The upper electrode 41 is attached to the first surface of the back plate 4 within the support device 31. The upper electrode 41 defines a plurality of apertures each for receiving a related one of the bosses of the anti-sticking device 45.

The diaphragm 2 is made of poly-crystalline silicon so that the upper electrode 41 and the diaphragm 2 together form a condenser wherein the diaphragm 2 is used as a lower electrode. When the sound reaches the diaphragm 2 through the acoustic apertures 43, the diaphragm 2 is deformed corresponding to the sound pressure. Accordingly, the capacitance of the condenser is changed.

According to the first embodiment of the present invention, the basic structure of the silicon microphone is made of poly-crystalline silicon by low pressure chemical vapor deposition (“LPCVD”). Diffusion and ion implantation are two means for doping silicon. Boron and phosphorous are commonly used dopant elements. The diaphragm 2 is made into a low-stress diaphragm by annealing.

The making of the anti-sticking device 45 is made by making the apertures in the upper electrode 41 by dry etching. Then, the protective layer 42 is deposited. Thus, the back plate 4 and its indentations are made. The indentations reduce the contact area between the back plate 4 and the diaphragm 2 during the making of an air gap 3 by wet etching so that the back plate 4 can easily be separated from the diaphragm 2 after the wet etching. Hence, the yield of the making of the silicon condenser microphone is increased. The air chamber 5 provides compressible air so that the diaphragm 2 can easily vibrate.

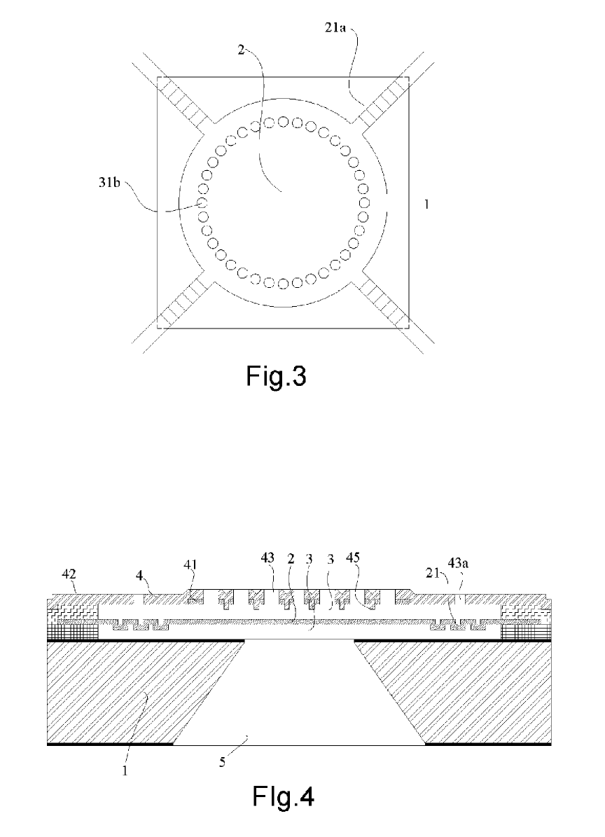

Referring to FIG. 3, there is a silicon condenser microphone according to a second embodiment of the present invention. The second embodiment is identical to the first embodiment except that the support device 31 includes bosses 31b instead of the annular ridge 31a. The bosses 31b are separated from one another and arranged along a circle. The bosses 31b define the effective area of the diaphragm 2 and separate the diaphragm 2 from the back plate 4.

Referring to FIG. 4, there is a silicon condenser microphone according to a third embodiment of the present invention. The third embodiment is like the first embodiment except omitting the support device 31.

The present invention has been described via the detailed illustration of the embodiments. Those skilled in the art can derive variations from the embodiments without departing from the scope of the present invention. Therefore, the embodiments shall not limit the scope of the present invention defined in the claims.

What is claimed is:

1. A silicon condenser microphone comprising:
a silicon substrate defining an air chamber;
a back plate mounted on the silicon substrate, the back plate comprising at least one acoustic aperture defined therein and a support device formed thereon;
a diaphragm arranged between the silicon substrate and the back plate so that an effective area thereof is determined by the support device; and
a suspension device arranged between the diaphragm and the silicon substrate so that lateral movement of the diaphragm is prevented while vertical movement of the diaphragm is allowed;
wherein an edge of the diaphragm is abutted against the support device when the diaphragm is moved towards the back plate.

2. The silicon condenser microphone according to claim 1 wherein the back plate comprises an anti-sticking device for avoid the sticking of the diaphragm to the back plate.

3. The silicon condenser microphone according to claim 1 wherein the anti-sticking device comprises a plurality of bosses made of a dielectric material.

4. The silicon condenser microphone according to claim 1 wherein the support device comprises an annular ridge.

5. The silicon condenser microphone according to claim 4 wherein the annular ridge is made of a dielectric material.

6. The silicon condenser microphone according to claim 1 wherein the support device comprises a plurality of bosses.

7. The silicon condenser microphone according to claim 6 wherein the bosses are arranged along a circle.

8. The silicon condenser microphone according to claim 6 wherein the bosses are made of a dielectric material.

9. The silicon condenser microphone according to claim 1 wherein the suspension device comprises at least one corrugated cantilever for supporting the diaphragm on the silicon substrate, thus allowing the vertical movement of the diaphragm while avoiding the lateral movement of the diaphragm.

10. The silicon condenser microphone according to claim 1 wherein the diaphragm is made of poly-crystalline silicon.

11. A silicon condenser microphone comprising:
a silicon substrate defining an air chamber;
a back plate mounted on the silicon substrate, the back plate comprising at least one acoustic aperture defined therein;
a diaphragm arranged between the silicon substrate and the back plate; and
a suspension device arranged between the diaphragm and the silicon substrate so that lateral movement of the diaphragm is prevented while vertical movement of the diaphragm is allowed;
wherein an edge of the diaphragm is abutted against the support device when the diaphragm is moved towards the back plate.

12. The silicon condenser microphone according to claim 11 wherein the suspension device comprises at least one corrugated cantilever for supporting the diaphragm on the silicon substrate, thus allowing the vertical movement of the diaphragm while avoiding the lateral movement of the diaphragm.

13. The silicon condenser microphone according to claim 11 wherein the diaphragm is made of poly-crystalline silicon.

14. The silicon condenser microphone according to claim 11 wherein the back plate comprises an anti-sticking device for avoiding the sticking of the diaphragm to the back plate.

15. The silicon condenser microphone according to claim 14 wherein the anti-sticking device comprises a plurality of bosses made of a dielectric material.
